(19) United States
(12) Patent Application Publication
(10) Pub. No.: US 2024/0103213 A1
(43) Pub. Date: Mar. 28, 2024

(54) MULTI-CORE OPTICAL FIBER

(71) Applicant: OFS Fitel, LLC, Norcross, GA (US)

(72) Inventors: Adam Hokansson, Granby, CT (US); Jie Li, Unionville, CT (US); Xiaoguang Sun, West Hartford, CT (US)

(73) Assignee: OFS Fitel, LLC, Norcross, GA (US)

(21) Appl. No.: 18/273,217

(22) PCT Filed: Jan. 24, 2022
(86) PCT No.: PCT/US22/13477

§ 371 Date: Jul. 19, 2023

Related U.S. Application Data
(60) Provisional application No. 63/141,739, filed on Jan. 26, 2021.

(51) Int. Cl. G02B 6/02; G02B 6/44

(52) U.S. Cl. CPC G02B 6/02042; G02B 6/4413

(57) ABSTRACT

A multi-core optical fiber comprises at least two (2) helical cores. When the multi-core optical fiber is bent, such that it has a bend length (L) and a bend radius (R), each core experiences a different strain, thereby resulting in an effective optical length difference (δl) between the cores. In the present disclosure, the helical cores have a pitch (P) that reduces δl/L to a value that is less than 5·10⁻⁶ (i.e., δl/L<5·10⁻⁶).

### CROSS REFERENCE TO RELATED APPLICATIONS

This application claims the benefit of U.S. provisional patent application Ser. No. 63/141,739, filed 2021 Jan. 26, by Sun, et al. and having the title “Optical Fiber Links with Matched Optical Lengths Using Spun Multicore Optical Fiber,” which is incorporated herein by reference in its entirety.

### BACKGROUND

### Field of the Disclosure

The present disclosure relates generally to optical systems and, more particularly, to optical fiber systems.

### Description of Related Art

Fiber-optic-based photonic links that use dual-core optical fibers are known in the art. For example, U.S. Patent Application Publication Number 2021/0318505A1, by Beranek et al. and having the title “Multicore Fiber Optic Cable,” which was published on 2021 Oct. 14 and incorporated by reference in its entirety as if expressly set forth herein, teaches a balanced intensity modulation with direct detection (IMDD) system that uses a dual-core optical fiber.

As in most optical signal transmission systems, maintaining signal integrity is important and, thus, there are ongoing efforts to improve optical signal transmission systems.

### SUMMARY

The present disclosure teaches a multi-core optical fiber that operates at an operating wavelength (λ). The multi-core optical fiber comprises at least two (2) helical cores. When the multi-core optical fiber is bent, such that it has a bend length (L) and a bend radius (R), each core experiences a different strain, thereby resulting in an effective optical length difference (δl) between the cores. In the present disclosure, the helical cores have a pitch (P) that reduces δl/L to a value that is less than 5·10⁻⁶.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a diagram showing a transverse cross-section of an embodiment of a multi-core optical fiber.

FIG. 2 is a diagram showing a perspective view of the multi-core optical fiber of FIG. 1.

FIG. 3 is a diagram showing a helical structure of one (1) of the cores of the multi-core optical fiber of FIGS. 1 and 2 when the multi-core optical fiber is bent (with a bend length (L) and a bend radius (R)).

### DETAILED DESCRIPTION OF THE EMBODIMENTS

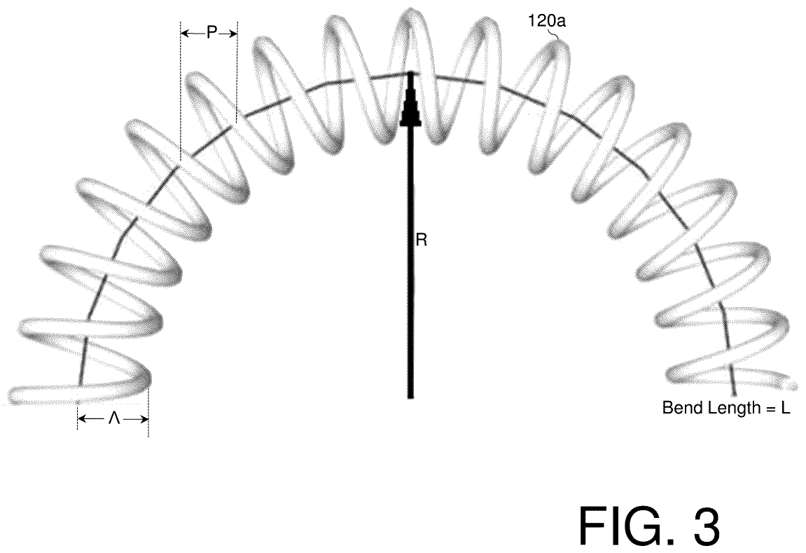

U.S. Patent Application Publication Number 2021/0318505A1, having the title “Multicore Fiber Optic Cable,” by Beranek et al. teaches a balanced intensity modulation with direct detection (IMDD) system that uses a dual-core optical fiber. A typical system is shown in FIG. 3 of Beranek, which shows a laser, a modulator, a balanced photodetector, and a dual-core optical fiber that is optically connected between an output of the modulator and the balanced photodetector. Because dual-core (or multi-core) IMDD systems are known to those having ordinary skill in the art, only a truncated discussion of IMDD systems is provided herein and reference is made to Beranek's published patent application for greater details relating to IMDD systems.

Beranek identifies that a drawback of dual-core IMDD (and similar) systems is that bending and temperature fluctuations sometimes affect the two (2) cores differently. As a result, the bend- or temperature-induced effects can induce different effective path lengths for the optical signals, oftentimes with unpredictable adverse consequences.

To mitigate for some of the bend or temperature effects, Beranek wraps the dual-core fiber around a central axial fiber, thereby creating a spiral with the dual-core fiber. To be clear, the two (2) cores in Beranek are not helical within the cladding itself. Rather, helicity is imparted to the entire fiber (including the cladding). By employing such a spiral geometry, Beranek seeks to negate link path length differences. Beranek's solution, however, requires the compensation of the path length differences after the dual-core fiber has been drawn. Such a post-draw compensation scheme introduces complications in manufacturing and, thus, adds to post-draw costs.

Unlike Beranek, the present disclosure teaches a different principle of operation by providing helical cores within the cladding (without the cladding itself being helical). In other words, rather than configuring the entire fiber (with both cladding and cores) into a spiral, the present disclosure configures the only the cores into a helical configuration (all within a non-spiral cladding). Thus, the inventive multi-core fiber in this application has helical cores vis-à-vis the cores themselves, but not vis-à-vis the cladding. By controlling the pitch (P) of the helical cores in a multi-core optical fiber with a bend (characterized by a bend radius (R) and a bend length (L)), the effective path length difference (δl) is reduced to less than 5·10⁻⁶·L.

Having provided a broad technical solution to a technical problem, reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

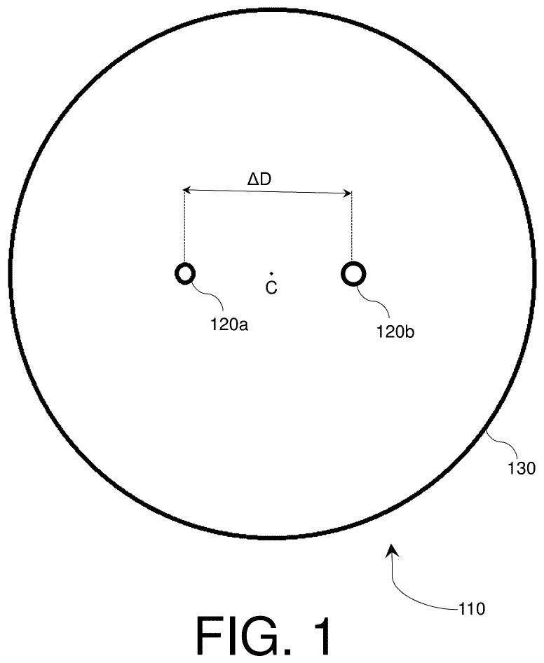

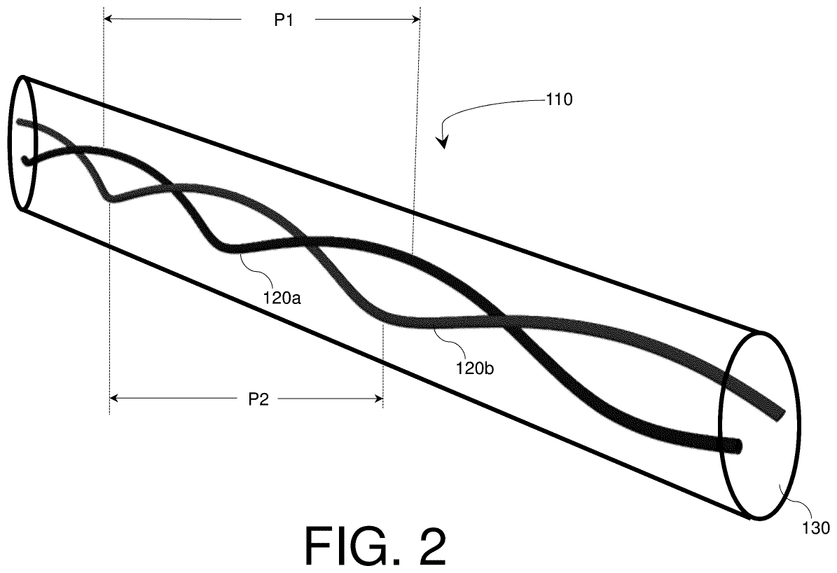

FIG. 1 is a diagram showing a transverse cross-section of an embodiment of a multi-core optical fiber, while FIG. 2 shows a perspective view of the multi-core optical fiber. For simplicity (and to avoid a cluttered drawing), FIG. 3 shows only one (1) helical core of the multi-core optical fiber of FIGS. 1 and 2.

In FIGS. 1 and 2, a dual-core optical fiber 110 is shown as an example embodiment of a multi-core optical fiber that is configured to carry optical signals at an operating wavelength (λ) (also known as a center wavelength). As shown in FIGS. 1 and 2, the dual-core optical fiber 110 comprises a first helical core 120a, a second helical core 120b, and a substantially cylindrical cladding 130.

The cladding 130 comprises a substantially circular transverse cross section with an axial center (C), which runs substantially parallel to a signal transmission axis of the dual-core optical fiber 110.

The first helical core 120a is located within the cladding 130 and radially offset from C by an offset distance of Λ1 (abbreviated as Λ in FIG. 3, insofar as only one (1) core is shown). Similarly, the second helical core 120b is also located within the cladding 130 and radially offset from C by a distance of Λ2 (not shown in the drawings). As shown in FIG. 1, the helical cores 120a, 120b are separated vis-à-vis each other by a core separation distance (ΔD). Preferably, the first helical core 120a and the second helical core 120b are symmetrically disposed on either side of C.

Of course, as is known in the art, each of the helical cores 120a, 120b has an effective core refractive index n1 and n2, respectively, at the operating wavelength of λ. Also, because of the geometry of a helix, each helical core 120a, 120b has an associated pitch (P1 and P2, respectively, as shown in FIG. 2), which defines the periodicity.

Continuing to FIG. 3, when the dual-core fiber 110 is bent, then the bend (having a bend radius (R) and a bend length (L)) imparts a corresponding bend to the helical core 120a. The bending of the helical core 120a induces respective periodic tension strains and compression strains at the peaks and troughs of the helical geometry. Significantly, if P1 and P2 are substantially the same (i.e., P1≈P2≈P), and P is less than L (i.e., P<L), then the helical cores 120a, 120b experience alternating tension strains and compression strains along L. Furthermore, if the two (2) cores 120a, 120b are disposed symmetrically about C, then a compression strain on the first helical core 120a corresponds with a tension strain on the second helical core 120b, and vice versa. It should be appreciated that, depending on L, the value of P will vary. A typical value for P can vary between approximately one centimeter (˜1 cm) and ˜10 cm.

By way of comparison, if there is a bend in the dual-core fiber without helical cores, then each of the non-helical cores experience different optical lengths (l). The difference in effective optical lengths (δl) for the two (2) non-helical cores is represented by:

δl≈0.76·n·(L/R)·ΔD [Eq. 1].

For example, a dual-core fiber with a core spacing of 62.5 μm can cause a maximum optical length difference of 400 μm. In a ten-meter (10 m) link, this corresponds proportionally to 4·10⁻⁵ of the total length.

However, as shown in the embodiments of FIGS. 1 through 3, because of the equal and opposite alternating compression strains and tension strains experienced by two (2) helical cores 120a, 120b, the difference in optical path length difference is reduced, and is mainly determined by the effective index difference between the two cores.

If the difference of effective index difference of the two cores is less than 5·10⁻⁶ (i.e., <5·10⁻⁶), then the corresponding optical path length difference is also <5·10⁻⁶.

If, however, effective index difference of the two cores is greater than 5·10⁻⁶ (i.e., >5·10⁻⁶), then the corresponding optical path length difference between the two cores of the dual-core fiber link can be further reduced by splicing together two (2) dual-core optical fibers with the respective cores switched. For example, if the optical path length difference between core-1 and core-2 of a first dual-core fiber (fiber-1) is δl, then a second dual-core fiber (fiber-2) with the same length difference is core-match-spliced (or connected) to fiber-1, but with the opposite cores aligned and spliced so that the optical path length difference from fiber-2 cancels the optical path length difference from fiber-1. In other words, core-1 of fiber-1 is spliced to core-2 of fiber-2, while core-2 of fiber-1 is spliced to core-1 of fiber-2, with the equal-and-opposite path length difference of fiber-2 canceling the path length difference that accumulated in fiber-1.

Continuing, if the disclosed dual-helical-core optical fiber 110 is used for the purpose of reducing laser relative intensity noise (RIN) in balanced IMDD (or similar) systems, then the RIN can be reduced up to twenty decibels (20 dB) (as compared to using one (1) single-core optical fiber with IMDD system). In other words, the disclosed multi-helical-core fiber 110 significantly reduces the RIN and improves the balance of the signal as it enters the balanced photodetectors for common-mode cancellation.

When compared to Beranek's teachings, by changing the underlying principle from a spiraling-an-entire-fiber configuration (such as that shown by Beranek) to a cores-only-helix configuration (as shown in FIGS. 1 through 3, above), the disclosed multi-helical-core fiber 110 is easier to manufacture and, for a sufficiently small pitch (P), able to compensate for smaller bends.

Any process descriptions or blocks in flow charts should be understood as representing logical functions or steps in a process and that alternative implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

Although exemplary embodiments have been shown and described, it will be clear to those of ordinary skill in the art that a number of changes, modifications, or alterations to the disclosure as described may be made. All such changes, modifications, and alterations should therefore be seen as within the scope of the disclosure.

What is claimed is:

1. A multi-core optical fiber comprising:
an operating wavelength (λ);
a bend comprising:
a bend length (L); and
a bend radius (R);
a transmission axis;
a cladding extending along the transmission axis, wherein the cladding comprises:
a substantially circular transverse cross section; and
an axial center (C);
a first helical core located within the cladding, wherein the first helical core is located radially offset from C by a first offset distance (Λ1), wherein the first helical core comprises:
a first pitch (P1) of P, wherein P<L; and
a first core effective index (n1) of n at λ;
a second helical core located within the cladding, wherein the second helical core is located radially offset from C by a second offset distance (Λ2), wherein the second helical core is separated from the first helical core by a core spacing distance (ΔD), wherein the second helical core comprises:
a second pitch (P2) of P; and
a second core effective index (n2) of n at λ; and
an effective optical length difference (δl) between the first helical core and the second helical core, wherein δl/L<5·10⁻⁶.

2. A fiber-optic signal transmission system, comprising:
a laser;
a modulator comprising:
a modulator input operatively coupled to the laser; and
a modulator output;
a balanced photodetector; and
a multi-core optical fiber optically connected between the modulator output and the balanced photodetector, wherein the multi-core optical fiber comprises:
an operating wavelength (λ);
a bend comprising a bend length (L) and a bend radius (R);
a transmission axis;
a cladding extending along the transmission axis, wherein the cladding comprises:
a substantially circular transverse cross section; and
an axial center (C);
a first helical core located within the cladding, wherein the first helical core is located radially offset from C by a first offset distance (Λ1), wherein the first helical core comprises:
a first pitch (P1) of P, wherein P<L; and
a first core effective index (n1) of n at λ;
a second helical core located within the cladding, wherein the second helical core is located radially offset from C by a second offset distance (Λ2), wherein the second helical core is separated from the first helical core by at least a core separation distance (ΔD), wherein the second helical core comprising:
a second pitch (P2), wherein P2≈P1; and
a second core effective index (n2) of n at λ; and
an effective optical length difference (δl) between the first helical core and the second helical core, wherein δl/L<5·10⁻⁶.

3. A fiber-optic signal transmission system, comprising:
a laser;
a modulator comprising:
a modulator input operatively coupled to the laser; and
a modulator output;
a balanced photodetector; and
a first multi-core optical fiber comprising:
a first fiber length;
a first fiber input end optically coupled to the modulator output;
a first fiber output end;
a first core having a first effective optical length (l1); and
a second core having a second effective optical length (l2);
a second multi-core optical fiber comprising:
a second fiber length that is substantially the same as the first fiber length;
a second fiber input end optically coupled to the first fiber output end;
a second fiber output optically coupled to the balanced photodetector;
a third core spliced to the second core to form a first optical path between the modulator and the balanced photodetector, the first optical path having a bend with a bend length (L), the third core having a third effective optical length (l3), l3 being substantially the same as l2;
a fourth core spliced to the first core to form a second optical path between the modulator and the balanced photodetector, the second optical path comprising the bend, the fourth core having a fourth effective optical length (l4), l4 being substantially the same as l1;
an effective optical path length difference (δl) between the first optical path and the second optical path, wherein δl/L<5·10⁻⁶.
